(19) United States
(12) Patent Application Publication
(10) Pub. No.: US 2008/0212871 A1
(43) Pub. Date: Sep. 4, 2008

(54) DETERMINING A THREE-DIMENSIONAL MODEL OF A RIM OF AN ANATOMICAL STRUCTURE

(76) Inventors: Lars Dohmen, Munchen (DE); Oliver Fleigi, Baldham (DE); Melanie Wegner, Kirchseeon (DE); Ingmar Hook, Feldkirchen (DE)

Correspondence Address: DON W. BULSON (BRAI), RENNER, OTTO, BOISSELLE & SKLAR, LLP, 1621 EUCLID AVENUE - 19TH FLOOR, CLEVELAND, OH, 44115, US

(21) Appl. No.: 12/029,716

(22) Filed: Feb. 12, 2008

Related U.S. Application Data
(60) Provisional application No. 60/890,671, filed on Feb. 20, 2007.

(30) Foreign Application Priority Data
Feb. 13, 2007 (EP) 07002993

(51) Int. Cl. G06K 9/00

(52) U.S. Cl. 382/154

(57) ABSTRACT

Determining a three-dimensional model of a rim of an anatomical structure using two-dimensional images of the rim. The images are taken from different directions and each image can provide a different two-dimensional contour of the rim. Corresponding pairs of points are identified in the images and are used with a transformation matrix to calculate the three-dimensional model. The model may then be used to assist physicians in implantation procedures.

### RELATED APPLICATION DATA

This application claims priority of U.S. Provisional Application No. 60/890,671 filed on Feb. 20, 2007, and EP 07002993 filed on Feb. 13, 2007, which are incorporated herein by reference in their entirety.

### FIELD OF THE INVENTION

The present invention relates to a method and system for using two-dimensional images to determine a three-dimensional model of a rim of an anatomical structure. The three-dimensional model is used to plan for and install implants, including artificial joints, enabling the implants to be positioned as exactly as possible.

### BACKGROUND OF THE INVENTION

When implanting an artificial hip joint, it is advantageous to view a three-dimensional model of the hip. This orientation allows an implantation of the artificial hip joint at a suitable location. Producing such a three-dimensional model from two-dimensional x-ray images can be difficult.

### SUMMARY OF THE INVENTION

A rim of an anatomical structure can be suitable to serve as an orientation aid for implanting an implant. It can be particularly suitable for implanting an artificial hip joint. The rim of the anatomical structure may be situated in the vicinity of a target area of the implant; and/or may be in contact with the implant after implantation; and/or may surround at least a part of the implant once successfully implanted. The rim of the acetabulum (socket of the hip joint) or the rim of the patella (kneecap) both represent examples of the rim of an anatomical structure.

To determine a three-dimensional model of the rim of an anatomical structure, a number of steps are performed. A method in accordance with the invention uses two-dimensional images that show the rim of the anatomical structure. These images may show different views of the rims from different directions (imaging directions), such that from two or more such images, the user or computer can determine spatial information about the anatomical structure. A two-dimensional contour of the rim may be determined in each of the images used to obtain the spatial information. With this information, the user or computer can determine the three-dimensional model of the rim of the anatomical structure.

If the two-dimensional images are x-ray images, then the rims of the anatomical structure may be identified by their contour or edge. Other imaging methods that produce projective images also can be used.

A method for identifying and determining the two-dimensional contour of an anatomical structure in the two-dimensional images can utilize input from an operator, or also can be performed automatically by a data processing device (e.g., a computer). To determine the contour or edge of the rim and define it as a contour line for further processing, an operator (e.g., a physician) can trace the contour of the rim using a mouse on a display screen on which a two-dimensional image of the rim is displayed. Each rim of the anatomical structure also has a characteristic shape. Using the shape and the other image information, it may be possible to automatically identify and determine the two-dimensional contour of the anatomical structure in a two-dimensional image. The automatic identification and determination process may use pattern recognition methods and/or contrast enhancing.

The two two-dimensional images may be obtained from different directions, and the shape of the line representing the contour of the rim in each of the two-dimensional images can be different. Information on the imaging conditions that change from image to image (relative imaging conditions) may be supplied. Alternatively, the information on the imaging conditions may be ascertained as detailed below. The information on the imaging conditions that change from image to image (relative imaging conditions) also may be referred to herein as “change information.” Using known relative imaging conditions and the two-dimensional contour of the rim determined for each image, a three-dimensional model of the rim of the anatomical structure can be calculated.

The relative imaging conditions may include information on the imaging geometry that changes from image to image (geometric relationship between the object and the image). The relative imaging conditions may include the imaging directions that differ from each other from image to image. The relative imaging conditions may include the relative location between the anatomical structure and the imaging apparatus that differs from image to image. The relative imaging conditions also may include the image plane of the imaging apparatus.

The change information can be described using matrices, such as are used in epipolar geometry. The matrices can be the essential matrix, the fundamental matrix and/or the localization matrix. The matrices describe the relative geometric relationship between the conditions on which the images are based and, for example, can include the relative locations of a set of focus points. Also, the matrices can describe projection points of the images and/or the relative location of the image planes. In general, the principle of epipolar geometry represents an intrinsic projective geometry between two views (imaging directions). Epipolar geometry depends on a set of internal parameters of the imaging devices used for imaging and their relative locations. The fundamental matrix represents this intrinsic geometry. The essential matrix represents a specific instance of the fundamental matrix. The localization matrix can be determined using the essential matrix and the principle of epipolar geometry.

Localization matrices are described in an article “3D Simultaneous Localization and Modeling from Stereo Vision” by Miguel Angel Garcia and Agusti Solanas.

So-called “epipolar” lines can be determined from the localization matrix in accordance with the principle of epipolar geometry. Points lying along an epipolar line represent candidates for so-called “correspondence points.” Correspondence points represent the same object point in different images. A correspondence point in one image has a corresponding point in the other image, which lies on an epipolar line in the other image.

The correspondence points, which are also referred to as homologous points, may be determined in the two-dimensional images. That is, corresponding points represent the same point (or region) of the anatomical structure (i.e., the same object point) in different images. Each correspondence point in one image has a correspondence point that corresponds to it in another image. The principle of correspondence points may be generally known from the principle of stereovision and epipolar geometry. For further information on the principle of epipolar geometry, see patent application EP 1 693 798 and the book “Epipolar Geometry in Stereo, Motion and Object Recognition: A Unified Approach” by Gang Xu, Zhengyou Zhang.

A correspondence point may be determined using the intersection point between an epipolar line, determined from the localization matrix, and the two-dimensional contour of the rim in one of the images.

Candidates for possible correspondence points may not include all the points along the epipolar line but rather only the intersection points between the two-dimensional contour of the rim and an epipolar line in one of the images. The epipolar line can be defined using a corresponding point in the other two-dimensional image. Since the contour of the rim usually represents a closed curve, there are usually two intersection points that represent possible candidates for a correspondence point. If the contour of the rim is discontinuously or convexly curved, there can be more than two intersection points. The principle of determining the two-dimensional contour of the rim may reduce the number of possible candidates, even down to two. To make a selection between the (two) candidates, it may be possible to ask the operator, or to use a point on the contour of the rim that may be as prominent as possible (an extreme point of the contour). As an example, the point furthest left or right and/or top or bottom may be used. In this manner, it may be possible to select from the two candidates the one that may be closest to a corresponding extreme point in the other image.

Once the corresponding correspondence point for a point in one image has been found in the other image, the other correspondence points along the contour of the rim can be determined. This determination can be automatic and can use the proximity relationship between the points. In other words, another point may be selected which can be adjacent to the first correspondence point already identified. The candidate point, that may be closest to the first correspondence point already identified, may be selected. In this manner, it may be possible to proceed point-by-point along the line, to automatically determine the correspondence points along the contour of the rim. The mutually corresponding points (correspondence points) in the different images each represent an object point. If there are two images, a pair of correspondence points can represent an object point. The three-dimensional location of the object point assigned to the correspondence points may be determined from the positions of the pairs of correspondence points in the images. The principles of epipolar geometry and the essential matrix or localization matrix can be used in the determination. The determined object points can be connected using a fitting function (for example a spline curve), to determine the three-dimensional model of the rim.

An anatomical structure detected by imaging can include anatomical landmarks. The three-dimensional location of at least one of the landmarks can be determined. Examples of landmarks in a hip joint endoprosthetic are the left and right spina anterior superior, points on the pubis, and/or the center of rotation of the right and left femur. The three-dimensional locations of the landmarks can be determined on the basis of at least two images using the principle of epipolar geometry. The locations of the landmarks may be determined relative to the model of the rim (or relative to the contour of the rim) and/or in a reference frame. For example, the reference frame of a navigation system can be used and the model of the rim may be known to the system. The landmarks may be points on the rim or in its vicinity. The desired location of the implant can be planned relative to these landmarks using a planning program. Determining the location of the landmarks relative to the rim allows determination of the actual location of the rim in an implantation procedure. The landmarks on the patient may be identified or traced by the physician using pointers (pointing apparatus with marker devices attached), or may be otherwise loaded into the system. If the location of the landmarks is “known” to a navigation system or navigation program, then the location of the rim can be determined in the reference frame of the navigation system. This determination may be based on the known relative location between the landmarks and the rim (determined from the images). Once a desired location of the implant relative to the location of the rim has been determined, the target location of the implant can be determined using the identified or traced landmarks. The target location can be used to guide the surgeon during the implantation procedure or can help the surgeon plan the procedure.

To determine the change information, marker devices or markers may be placed in locations relative to the anatomical structure that remain the same for at least two images. The markers can be configured such that they are detected by the imaging procedure. If the images are x-ray images, then the markers can be radio-opaque metal spheres (e.g., made of a metal having a high atomic number, preferably over 20). Such metals including tungsten can be detected by x-ray imaging. The markers or marker devices can be attached to the anatomical structure, adhered onto the patient's skin, or secured fixedly to the patient's body. The markers also can be part of a frame into which the patient can be fixed. The patient's body then remains immobile while the two images are taken (from different imaging directions). The patient also can be rotated while the imaging apparatus remains stationary. The markers may have a known location with respect to each other. The markers may be embodied differently, for example with regard to shape and/or size, such that they can be identified and distinguished in the respective images. Correspondence points that correspond to the identified markers can be defined. Using the correspondence points and the principles of epipolar geometry, the change information can be calculated in the form of an essential matrix and/or a localization matrix. The calculated change information may be utilized in the described calculation of the three-dimensional model of the rim.

The three-dimensional model can be calibrated, in particular with regard to the distances. The calibration can be performed using known distances between markers.

The change information can alternatively or additionally be determined as follows. It may be possible to change and measure the locations and/or orientations of the imaging apparatus relative to each other from image to image while the patient can remain stationary. A marker device can be attached to an imaging apparatus. The location of the imaging apparatus relative to the imaging plane and/or projection point or focus point of the imaging apparatus can be known. The locations of the imaging plane, projection point, and/or focus point may be determined by a navigation system or by a suitable detection device using the location of the marker device. The system or device may have a computer connected to it to assist in the determination. In this manner, it is possible to determine the change information or the localization matrix for the two images.

As already mentioned above, a method in accordance with the invention for determining the three-dimensional model of a rim can be helpful in planning the implantation of an implant. To benefit from this help, a three-dimensional model of an implant may be provided. The location of the implant model relative to the rim model may be selected to be a variable in a simulation method. The locations of the implant model and the rim model may be determined in a reference frame and displayed on a display device. An operator or physician can choose a suitable location of the implant model relative to the rim model. The implant model may be optimally adapted to the location of the rim model.

In accordance with another embodiment of the invention, additional criteria can be provided and used to determine a relative location between the rim model and the implant model. Such criteria can include a desired distance and/or alignment between an implant axis or an implant plane of symmetry and the rim model. A plane can be placed through the rim model. The orientation of this plane relative to an axis of symmetry of the implant model may be predetermined as being suitable for implantation. This relative location can be suitable for implantation or can serve as a starting point for further refining the location.

In accordance with another embodiment of the invention, a method can support an implantation procedure. This support may be provided using the rim model (determined beforehand). Points on the rim and/or the aforementioned landmarks may be identified, entered, inputted, or otherwise provided. The points and/or landmarks represent registration data that can be used in a reference frame of a navigation system. The rim model (determined beforehand) can be registered in the reference frame of the navigation system using the registration data. A target location of the implant model relative to the rim model can be established using the aforementioned method for planning an implantation. The target location also can be provided directly into the navigation system. Using the target location of the implant model relative to the rim model and further using the registered rim model, it may be possible to calculate the target location of the actual implant in the reference frame of the navigation system. To support the surgeon in positioning the implant, implant position data may be captured that represents the location of the implant in the reference frame of the navigation system. A marker device can be attached to the implant, that can be detected using a detection device of the navigation system. The actual location of the implant can be measured in the reference frame of the navigation system and compared with the calculated target location of the implant. The target location of the implant and the actual location of the implant can be displayed on a display screen, so as to provide a surgeon with a navigation aid. Alternatively, information can be provided to the surgeon regarding given distances or deviations between the actual location of the implant and the target location. Information can further be provided regarding the direction in which the actual implant should be tilted, rotated, or moved.

The method and the various embodiments disclosed herein may be at least partially implemented via a computer that executes a computer program. The computer program can be provided on a computer readable medium such that when executed by the computer, carries out the method in accordance with the invention.

The present invention also relates to a device comprising a computer or data processing device and a program that can be stored in and/or run on the computer or data processing device. The program can be the aforementioned computer program. A detection device also may be provided for detecting marker devices and/or pointers. The marker devices may be attached to the implant, an anatomical structure, the patient, or an imaging apparatus. A pointer can be used to identify the location of the implant, the anatomical structure, the patient, or the imaging apparatus. Signals detected by the detection device are provided to the data processing device or computer and processed by the computer program. The signals represent the location of the implant, the anatomical structure, the patient, or the imaging apparatus. If the location of the imaging apparatus changes between the two images, while the location of the patient does not change, then the change information can be determined from the detected signals. The localization matrix can be determined by the computer program. The aforesaid device can be used to determine a three-dimensional model of a rim of an anatomical structure and/or to plan an implantation of an implant.

A device in accordance with invention also relates to a navigation system for navigating an implant or instrument relative to an anatomical structure. The navigation system may include the aforesaid device and a display device. A computer program can be running or stored on the computer or data processing device. When executed, the program can determine the location of the rim of the anatomical structure in accordance with the aforementioned method.

### BRIEF DESCRIPTION OF THE DRAWINGS

The forgoing and other features of the invention are hereinafter discussed with reference to the figures.

FIG. 1a and FIG. 1b show two x-ray recordings from different directions.

FIG. 2 shows a detail from one of the two x-ray recordings (AP), with the contour of the rim drawn in.

FIG. 3 shows the other of the two x-ray recordings (oblique direction), with the contour of the rim drawn in.

FIG. 4 shows an x-ray recording (oblique direction), with the implant three-dimensionally superimposed.

FIG. 5 shows an example arrangement of marker elements of a deformable marker device.

FIG. 6 schematically shows a device and a navigation system in accordance with the present invention.

FIG. 7 and FIG. 8 are images of a pelvic model, to illustrate an anatomical rim.

FIG. 9 schematically shows an exemplary data processing device, or computer, in accordance with the present invention.

### DETAILED DESCRIPTION

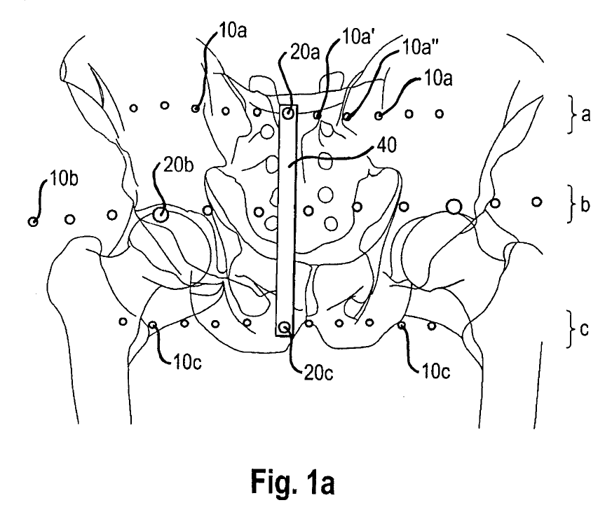

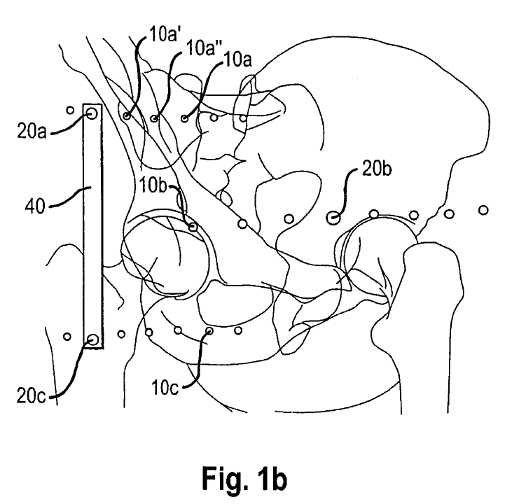

FIG. 1a shows an x-ray recording from the anterior-posterior direction (referred to in the following as AP direction for short). FIG. 1b shows an x-ray recording from an oblique direction. The two images represent the same human pelvis, from different directions. Circular areas (or black spots) 10 and 20, each arranged in a line a, b or c, can be seen in each recording. These lines “a” (upper line), “b” (middle line), and “c” (lower line) are referred to in the following as “lines of circles.” The diameter of the circular areas 10, 20 may be the same within each of the lines of circles. Alternatively, some of the circular areas, for instance circular areas 20, may be larger than the other circular areas 10. The circular areas 10, 20 shown are created by arranging marker spheres which are impermeable or hardly permeable to x-ray radiation around the patient, in this instance around the pelvis. The location of the marker spheres relative to the pelvis can be the same in the two recordings. Further details in this respect are disclosed by a provisional patent application entitled “Deformable Marker Device,” Ser. No. 60/891,794 filed by the Applicant on Feb. 27, 2007, which is hereby incorporated by reference in its entirety. In FIGS. 1a and 1b, the upper and lower rows of marker spheres, that create the upper and lower lines of circles “a” and “c” in each of the images, are arranged in front of the pelvis. The middle row of marker spheres that creates the middle line of circles “b” in the images is arranged behind the patient's pelvis. The distance between the two large marker spheres 20a and 20c on the front side may be known and may be fixed, for example, by a rod 40. When the x-ray recording from the AP direction (FIG. 1a) is compared with the recording from the oblique direction (FIG. 1b), it can be seen that the middle line of circles “b” appears shifted as compared to the upper “a” and lower “c” line of circles. This is due to the different viewing angle. From the shift in the line of circles relative to each other, in particular the shift in the large circular areas 20 in each of the rows, it is possible to determine the “change information.” In particular, it is possible to determine the change in the imaging direction, between the two images. The correspondence points can be determined from the identifiable large circular areas 20. The large circular area 20 in each line of circles in the image in FIG. 1a, for instance, may correspond to the corresponding large circular area 20 in the corresponding line of circles in the image in FIG. 1b. Starting from this large circular area (e.g., 20a), it is possible to proceed to the nearest small circular area (e.g., 10a′). From this nearest small circular area (e.g., 10a′), it is possible to proceed to a small circular area nearest to it (e.g., 10a″), and so on. The process may be repeated to gradually determine the corresponding correspondence points, until all or a sufficient number of the circular areas shown in the two images have been identified. The correspondence points may be determined in pairs, wherein each pair is created by a marker sphere that differs in its location from the other marker spheres. The change information and the localization matrix can be determined using these correspondence points and the principles of epipolar geometry.

From the known point correspondences in a series of two or more images, it is possible to calculate the “essential matrix.” The essential matrix may include the rotation between the individual imaging apparatus (or camera) positions and the shift vector of the camera center from one recording to the next (the gauging factor may be unknown). Various approaches to calculate the essential matrix are known: an eight-point algorithm by Longuit-Higgins; a modification by Hartley; and a five-point algorithm by Stewénius/Engels/Nistér. For further information see:
H. Christopher Longuit-Higgins (September 1981). “A computer algorithm for reconstructing a scene from two projections.” Nature 293: 133-135.
R. I. Hartley. “In defence of the 8-point algorithm,” 1995, Proceedings of the Fifth International Conference on Computer Vision, table of contents.
H. Stewénius, C. Engels and D. Nistér. “Recent Developments on Direct Relative Orientation,” to appear in ISPRS Journal of Photogrammetry and Remote Sensing.
   In general, there are at least two approaches: (1) algorithms that minimize the back-projection error via an optimization method, and (2) algorithms that directly calculate the matrix algebraically.

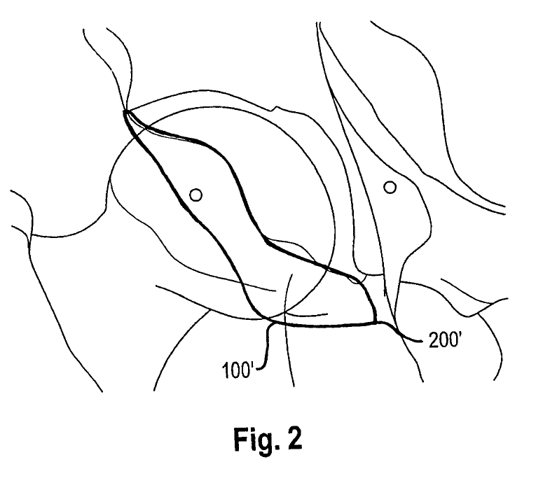

Turning now to FIG. 2, a detail is shown from an x-ray image taken in the AP direction. The rim of the acetabulum, which appears as a contour in the x-ray image, has been traced by hand. The closed line 100′ represents a determined two-dimensional contour of the rim in one image. The black circular areas represent marker spheres.

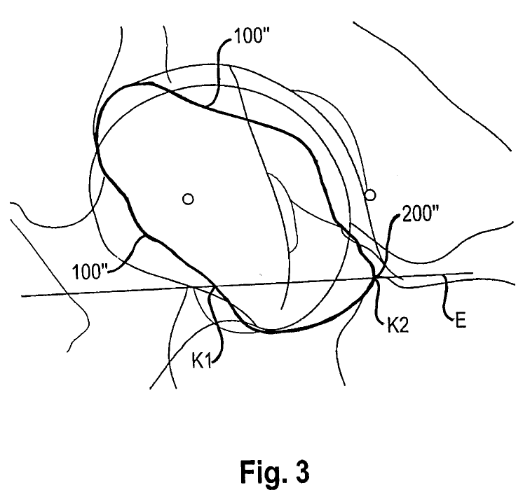

FIG. 3 shows a corresponding image taken from the oblique direction. A closed line 100″ (drawn by hand and shown in black) can be seen in this image and represents the contour of the rim (socket rim). The black circular areas represent marker spheres.

From these images, both the change information (as explained above in the discussion associated with FIG. 1a and FIG. 1b) and the two-dimensional contour of the rim in each case (as explained above in the discussion associated with FIG. 2 and FIG. 3) can be determined. For this determination, FIG. 2 represents a detail view from FIG. 1a and FIG. 3 represents a detail view from FIG. 1b.

Using the two two-dimensional contours of the rim (closed line 100′ in FIG. 2 and closed line 100″ in FIG. 3), it is possible to determine correspondence points along the rim. In this example, the determination begins with selecting a point 200′ furthest right on the line in FIG. 2. An epipolar line in the image may be assigned to this point 200′ furthest right using the localization matrix. This epipolar line is illustrated in FIG. 3 by the line E. Assignment of epipolar lines is discussed in “3D Reconstruction of Scoliotic Spines from 2D Plain Radiographs” by Ahmad Farshoukh and Adel Fakih, American University of Beirut, 3^{rd} FWA Student Conference Proceedings, May 27-28, 2004, pp. 308-312, incorporated herein by reference. Epipolar lines may be determined by using the Bresenham algorithm (Z. Chen, C. Wu, H. T. Tsui, “A New Image Rectification Algorithm,” Pattern Recognition Letters 24 (2003) pp. 251-260), also incorporated herein by reference. The intersection points between the epipolar line E and the two-dimensional contour of the rim 100′ in FIG. 3 are possible candidates K1 and K2 for a correspondence point. Of these two possible candidates K1 and K2 in FIG. 3, the point K2 furthest right may be selected and represents the correspondence point 200″ with respect to the point 200′ in FIG. 2. In this example, the selection of K2 is based on a comparison of the 2D contours in the pair of images and the knowledge that FIG. 2 is taken in the AP direction and FIG. 3 is a corresponding image taken in the oblique direction. Thus, a pair of correspondence points 200′ and 200″ are obtained and defined.

Once the first pair of correspondence points has been defined, it may be possible to proceed step-by-step by selecting a point adjacent to the first point as the next point in FIG. 2. An epipolar line with respect to this point is illustrated in FIG. 3. Referring back to the two intersection points and possible candidates, the intersection point that is adjacent to the first correspondence point can be selected. In this manner, another pair of correspondence points can be obtained and defined.

The procedure just described may be continued and repeated until a plurality of pairs of correspondence points are defined on the two contours of the rim. An object point in three-dimensional space can be assigned to each pair of correspondence points using the determined localization matrix in accordance with the principles of epipolar geometry. In other words, the three-dimensional location of a point on the three-dimensional model of the rim can be determined from a pair of correspondence points. The three-dimensional locations of a plurality of object points along the three-dimensional model of the rim can be obtained from the plurality of pairs of correspondence points. These object points can be connected (using curve fitting functions, for example spline functions) to determine a continuous three-dimensional model of the rim.

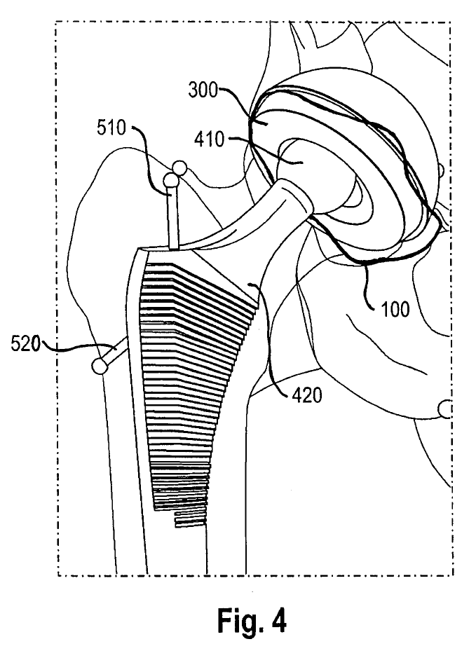

The image shown in FIG. 4 represents an example of a display image, with which a surgeon can plan the implantation of an artificial hip joint. The background in FIG. 4 shows an x-ray recording of the pelvis from an oblique direction. The foreground shows the calculated three-dimensional edge or model 100 of the socket rim relative to the pelvis. An artificial socket joint 300 may be fitted within the contour 100. An artificial head joint 410 together with an artificial shaft 400 are also shown. A pair of “drawn-in” axes represent a femoral neck axis 520 and a femur axis 510. From a surgeon's perspective, the axes represent reference orientations for locating the implant.

The location of the artificial socket joint 300, 410, 420 can be varied relative to the location of the rim contour 100, using the program, until the artificial socket joint has assumed a location which appears suitable to the physician or surgeon. Using the planning software and the drawn-in axes, the physician can position the artificial socket joint 300, head joint 410, and shaft 420 relative to the location of the rim contour 100.

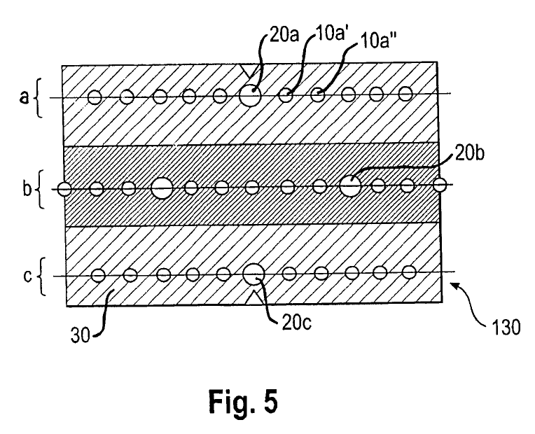

FIG. 5 shows an example of a deformable marker device 130 that can be used in accordance with the invention. The device is intended to have the shape of a cuff or a waistband, wherein the lines “a” and “c” are in front of the pelvis and the line “b” is behind it. FIG. 5 further shows the arrangement of marker elements 10 and 20 along lines “a,” “b,” and “c.” The marker elements may be marker spheres and may be attached to a cloth 30.

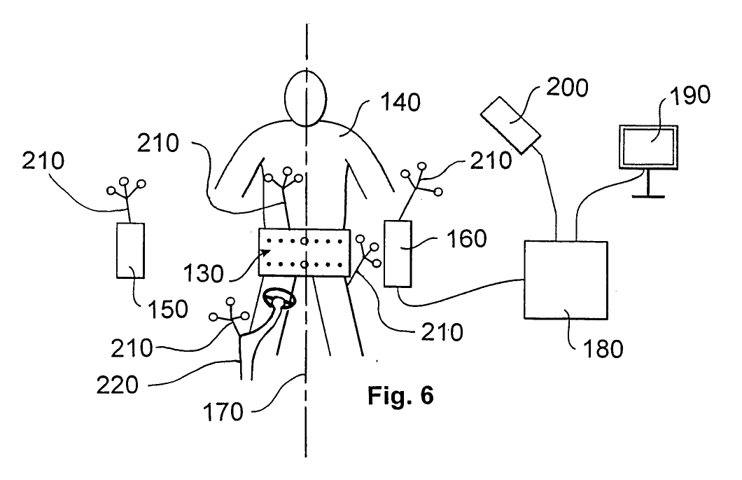

FIG. 6 schematically shows a configuration (device and navigation system in accordance with the invention) such as can be used to determine the model of the socket rim and in planning for or performing an operation. The deformable marker device 130 may be positioned or wrapped around a patient 140. It may be situated at the level of the pelvis. The pelvis can be irradiated with x-ray light from an x-ray source 150. The x-ray light that has passed the marker device 130 and the pelvis may be detected by an x-ray detector 160. The patient can be rotated about his/her longitudinal axis 170 between two x-ray image recordings, to obtain an image from the AP direction and an oblique image. The resulting signals from the x-ray detector 160 can be transmitted from the detector 160 to a data processing device 180 (e.g., a computer). Reproductions of the x-ray images can be viewed on a display screen 190 connected to the computer 180, on which a software program in accordance with the present invention may be running or may be stored. A detection device 200 is connected to the computer 180 and detects optically detectable markers. One or more optically detectable markers 210 may be attached to the patient 140, the deformable marker device 130, the x-ray source 150 or detector 160, and/or even an implant 220. The markers may be optically detectable markers that also can be detected in x-ray recordings or that are in a fixed geometric position relative to the x-ray markers 10, 20.

With markers 210 attached to the patient 140 or the marker device 130, it may be possible to register the patient. Registration may be required for navigation, during or at the beginning of a procedure. The procedure may have to be performed shortly after the x-ray recordings have been taken, as the marker device should not shift relative to the anatomy. If an operation is to be performed, then the deformable marker device 130 may be removed beforehand.

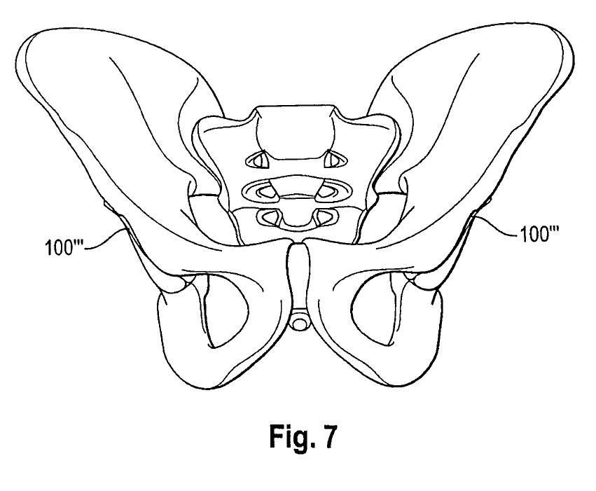

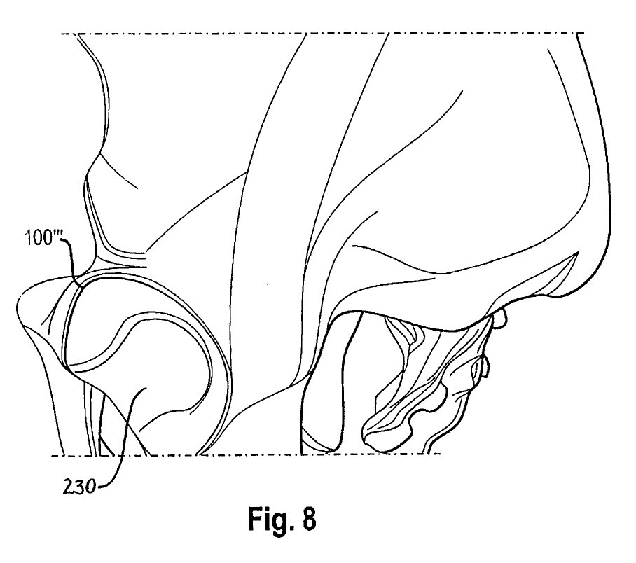

FIG. 7 and FIG. 8 show images of a pelvic model, in which the contour of a pelvic rim 100′″ is shown. FIG. 7 is a view from the front and FIG. 8 is a lateral view of the pelvis. The contour of the rim 100′″ is modeled using the method in accordance with the invention.

A recess 230 may be formed in the inner region of the socket rim and can be seen in FIG. 8. It may be possible to interpolate via the recess 230, to determine a plane which lies approximately on the socket rim 100′″ and can likewise serve as an orientation parameter for positioning or planning the positioning of an implant.

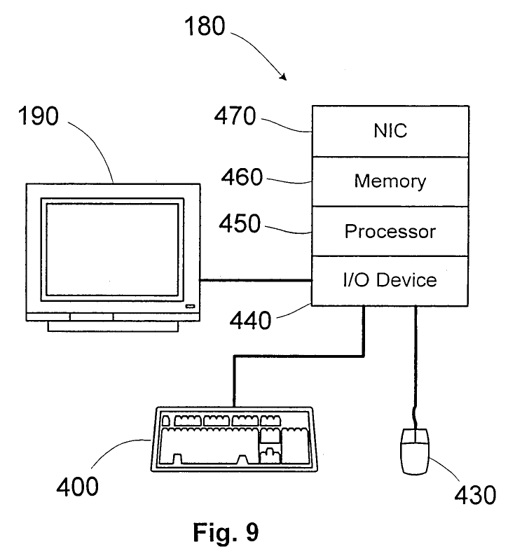

Moving now to FIG. 9 there is shown a block diagram of an exemplary data processing device or computer 180 that may be used to implement one or more of the methods described herein. The computer 180 may be a standalone computer, or it may be part of a medical navigation system, for example. The computer 180 may include a display 190 for viewing system information, and a keyboard 400 and pointing device 430 for data entry, screen navigation, etc. A computer mouse or other device that points to or otherwise identifies a location, action, etc., e.g., by a point and click method or some other method, are examples of a pointing device 430. Alternatively, a touch screen (not shown) may be used in place of the keyboard 400 and pointing device 430. The display 190, keyboard 400 and mouse 430 communicate with a processor via an input/output device 440, such as a video card and/or serial port (e.g., a USB port or the like).

A processor 450, such as an AMD Athlon 64® processor or an Intel Pentium IV® processor, combined with a memory 460 execute programs to perform various functions, such as data entry, numerical calculations, screen display, system setup, etc. The memory 460 may comprise several devices, including volatile and non-volatile memory components. Accordingly, the memory 460 may include, for example, random access memory (RAM), read-only memory (ROM), hard disks, floppy disks, optical disks (e.g., CDs and DVDs), tapes, flash devices and/or other memory components, plus associated drives, players and/or readers for the memory devices. The processor 450 and the memory 460 are coupled using a local interface (not shown). The local interface may be, for example, a data bus with accompanying control bus, a network, or other subsystem.

The memory may form part of a storage medium for storing information, such as application data, screen information, programs, etc., part of which may be in the form of a database. The storage medium may be a hard drive, for example, or any other storage means that can retain data, including other magnetic and/or optical storage devices. A network interface card (NIC) 470 allows the computer 180 to communicate with other devices.

A person having ordinary skill in the art of computer programming and applications of programming for computer systems would be able in view of the description provided herein to program a computer system 180 to operate and to carry out the functions described herein. Accordingly, details as to the specific programming code have been omitted for the sake of brevity. Also, while software in the memory 460 or in some other memory of the computer and/or server may be used to allow the system to carry out the functions and features described herein in accordance with the preferred embodiment of the invention, such functions and features also could be carried out via dedicated hardware, firmware, software, or combinations thereof, without departing from the scope of the invention.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed Figures. In particular regard to the various functions performed by the above described elements (components, assemblies, devices, software, computer programs, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method for determining a three-dimensional model of a rim of an anatomical structure, comprising:
providing at least two two-dimensional images of the rim, wherein each image is obtained under different imaging conditions such that each image provides a different view of the rim;
determining a two-dimensional contour of the rim in each of the at least two images;
calculating change information from the different imaging conditions used to obtain the at least two two-dimensional images of the rim; and
calculating a three-dimensional model of the rim using the two-dimensional contours from each of the at least two images and the calculated change information.

2. The method according to claim 1, wherein the change information is expressed in a matrix.

3. The method according to claim 2, wherein the change information is determined using epipolar geometry.

4. The method according to claim 3, wherein the matrix is a fundamental matrix, an essential matrix, or a localization matrix.

5. The method according to claim 1, further comprising:
determining correspondence points in the images; and
determining three-dimensional locations of imaged points and/or imaged regions using the correspondence points and the change information.

6. The method according to claim 1, further comprising:
determining an epipolar line; and
determining a correspondence point at an intersection point between the epipolar line and the two-dimensional contour of the rim in one of the images.

7. The method according to claim 6, further comprising:
determining additional correspondence points along the contour of the rim using a proximity relationship to the correspondence points already determined.

8. The method according to claim 1, further comprising:
determining three-dimensional locations of landmarks of the anatomical structure included in the images relative to the contour of the rim.

9. The method according to claim 8, wherein determining the three-dimensional locations of landmarks is based on the images and the imaging conditions.

10. The method according to claim 1, further comprising identifying corresponding pairs of marker images in each of the images.

11. The method according to claim 10, wherein identifying corresponding pairs of marker images is based on the size and/or shape of the marker images.

12. The method according to claim 11, wherein identifying corresponding pairs of marker images is further based on imaging direction information and on an assumption that a spatial relationship between the markers and the anatomical structure is the same for the at least two two-dimensional images.

13. The method according to claim 10, further comprising calibrating the three-dimensional model of the rim based on a known distance and/or relative location between at least two of the markers that are visible in the images as marker images.

14. The method according to claim 10, wherein the corresponding pairs of marker images are used in calculating the change information from the different imaging conditions used to obtain the at least two two-dimensional images of the rim.

15. A method for planning an implantation of an implant by simulating the alignment of the implant, comprising:
providing at least two two-dimensional images of the rim, wherein each image is obtained under different imaging conditions such that each image provides a different view of the rim;
determining a two-dimensional contour of the rim in each of the at least two images;
calculating change information from the different imaging conditions used to obtain the at least two two-dimensional images of the rim;
calculating a three-dimensional model of the rim using the two-dimensional contours from each of the at least two images and the calculated change information;
providing an implant model that represents a three-dimensional model of an implant; and
determining a location of the implant model relative to the rim model.

16. The method according to claim 15, further comprising displaying the relative location of the implant model and the rim model relative to at least one part of the anatomical structure.

17. The method according to claim 15, further comprising calculating one or more relative locations of the implant model based on predetermined criteria for the relative location of implant model to the rim model.

18. A computer program embodied on a computer readable medium for determining the three-dimensional model of a rim of an anatomical structure, comprising:
code that provides at least two two-dimensional images of the rim, wherein each image is obtained under different imaging conditions such that each image provides a different view of the rim;
code that automatically determines a two-dimensional contour of the rim in each of the at least two images;
code that calculates change information from the different imaging conditions used to obtain the at least two two-dimensional images of the rim; and
code that calculates a three-dimensional model of the rim using the two-dimensional contours from each of the at least two images and the calculated change information.

19. A system for supporting a physician in performing a procedure to implant an artificial implant into an anatomical structure, comprising:
optically detectable marker devices configured for attachment to:
a) a patient,
b) a deformable marker device, and/or
c) the implant;
a detection device configured for detecting and tracking the locations of the marker devices; and
a data processing device operatively coupled to said detection device, said data processing device comprising
a processor and memory, and
logic stored in the memory and executable by the processor, said logic including
i) logic that determines a rim model representing a three-dimensional model of a rim of the anatomical structure;
ii) logic that detects the locations of points on the rim model and/or landmarks, in a reference frame of a navigation system;
iii) logic that registers the rim model in the reference frame;
iv) logic that calculates a target location of the implant in the reference frame based on predetermined criteria;
v) logic that detects the actual location of the implant in the reference frame; and
vi) logic that outputs information on the target location of the implant and the actual location of the implant and/or the deviation between the actual location of the implant and the target location.

20. The device according to claim 19, further comprising a display device that is operably connected to the data processing device and configured to display the location of the implant and the location of the rim of the anatomical structure.
